(19) United States
(12) Patent Application Publication
(10) Pub. No.: US 2014/0373741 A1
(43) Pub. Date: Dec. 25, 2014

(54) CONTAINER DECORATION

(71) Applicant: Crown Packaging Technology, Inc., Alsip, IL (US)

(72) Inventor: Ian Wilkinson, Yorkshire (GB)

(21) Appl. No.: 14/376,166

(22) PCT Filed: Jan. 24, 2013
(86) PCT No.: PCT/EP2013/051352

§ 371 Date: Aug. 1, 2014

(30) Foreign Application Priority Data
Feb. 1, 2012 (EP) 12153525.6

(51) Int. Cl. B41F 31/13; B41F 17/28

(52) U.S. Cl. CPC B41F 31/13; B41F 17/28
USPC 101/367; 101/483

(57) ABSTRACT

Application of decoration in the form of coloured ink or inks onto a metal container uses an inking station with a roller train including oscillating rollers. These oscillating rollers use cam driven axial movement of an outer shaft which is transmitted to the outer face of the oscillating roller body and distributes ink uniformly across the adjacent roller. Rotation of the oscillating roller body is through contact with adjacent rollers in the inking station.

### TECHNICAL FIELD

This invention relates to container decoration. In particular, but not exclusively, it relate to an apparatus and method for the application of decoration in the form of coloured ink or inks onto a metal container. The container is typically a can body, and formed from tin free steel, aluminium or other metal.

### BACKGROUND ART

Decorating machinery has been employed by companies such as Rutherford and Alcoa in the printing of metal cans. Rutherford Machinery Company uses a dry offset printing method for good quality results which largely depends on the ink distributing system. The dry offset process uses no actual fluids such as water or oil in the process (hence “dry”) and the printed image is not directly applied to the can, i.e. it is “offset”.

Ink which contains all the correct properties for the process is conveyed in an “ink station” or “inker”. Each inker conveys a single colour of ink. In the Rutherford decorator, there are up to six or eight inker units, each of which applies ink of the required colour to images on printing plates. The printing plates in a Rutherford decorator are suspended at the bases of the inker units, via roller systems.

The ink on the images of the printing plates is then transferred to the printing blankets. In the Rutherford decorator, before the blankets contact the can, each blanket will have printed on it all the images contained in the design.

Thus the Rutherford decorator operates with three basic steps:
Ink to plate;
plate to blanket; and
blanket to can.

Each of these steps require the correct amount of contact pressure in order to ensure good definition, no missing parts of the design, and clear colouring with distinct lettering. The problem addressed by all decorators is insuring correct contact pressure throughout the process. If the contact pressure is insufficient, there is a risk of poor quality image on the final can. At the other extreme, too much contact pressure can result in blurring, in particular if the roller surface is rubberised compound which could be compressed and distort the image.

The Alcoa machinery for decorating aluminium and steel cans is based on three large rotary assemblies which are linked by synchronised drive trains. The three rotary assemblies in the Alcoa (or “Concord”) decorator comprise:
mandrel wheel;
blanket wheel; and
disc transfer wheel.

Cans are loaded onto individual mandrels on the mandrel wheel. The blanket wheel is mounted together with ink stations on an “inker frame”. As the mandrel wheel rotates, the blanket wheel also rotates, bringing each blanket into contact with an ink station. The ink station applies a film of ink to a rotating plate cylinder through a series of rolls. Each plate cylinder picks up only one colour of ink from the ink station, which it then brings into contact with a blanket. The blankets on the blanket wheel contact every plate cylinder in the ink station sequence. When a blanket has completed its cycle, it contacts a can on the mandrel wheel.

In the Alcoa Concord decorator, a complete design is transferred to the can on the mandrel when the can contacts the blanket. A pre-spin of the can before contact allows the design to be printed correctly around the whole circumference of the can. An overvarnish is applied and an air jet through the mandrel blows the can onto a transfer wheel where it is held by vacuum. The can is then taken to a peg chain and placed on a peg by release of the vacuum.

As well as controlling machine set-up and inter-roller pressure, as noted above, another particular problem which decorators have to address is the heat generated by the drive and by the moving parts, in particular in the inker stations. The temperature of the ink affects its viscosity. If the ink temperature is too low, the ink is too thick and viscous and consequently hard to smooth. On the other hand, it the temperature is too high, the ink is too thin and therefore spreads too easily and may look misty.

The present invention seeks to provide improvements to inker stations for use on decorators such as those of the prior art and not only to reduce the heat generated by known decorators but also to enable easy adjustment of component parts whilst maintaining image quality through correct contact pressure and temperature control.

### Summary of invention

According to the present invention, there is provided an inking station for a can body decorator, the inking station comprising: a fountain tank for holding and/or releasing ink; a blade for metering ink from the tank to a fountain roll; a series of rollers for transferring ink from the fountain roll to a plate cylinder; and in which the series of rollers includes at least one oscillating roller; characterised in that: each oscillating roller comprises: a fixed shaft, a clamp for fixing the position of the fixed shaft, a drive shaft movable relative to the fixed shaft, a cam for controlling movement of the drive shaft, an outer shaft connected to the drive shaft and moveable in response to the cam controlled movement of the drive shaft, and an oscillating roller body which is rotatable when, in use, it contacts adjacent rollers in the inking station; whereby, in use, the cam driven axial movement of the outer shaft is transmitted to the outer face of the oscillating roller body and distributes ink uniformly across the adjacent roller, and contact of the outer oscillator roller body with adjacent rollers rotates the outer face of the roller.

The “blade” may simply be an edge of the fountain tank. The series of rollers is sometimes also referred to as an ink train which transfers the ink from fountain roll to the printing plate or printing plate cylinder.

The inking station of the present invention has easy adjustment of component parts whilst maintaining correct contact pressure. The oscillating rollers thus distribute ink uniformly across the roller and “smooth out” any excess ink which may have been transferred during the process.

In a preferred embodiment, the drive shaft and outer shaft of the osciallting roller include complementary biasing means such that oscillating movement of the drive shaft causes the outer shaft to move axially over the fixed shaft.

The oscillating roller may have a slot through which a pin of the drive shaft, in use, moves the outer shaft of the oscillating roller. Typically, the outer shaft is mounted on roller bearings.

The inking station of the invention may further comprise a housing for the oscillating roller or rollers. This housing may be a cam box and the cam is a flat faced cam arrangement for each oscillating roller.

In a preferred embodiment, the inking station further comprises a drive for the inker rollers, and the inker drive is connected via one or more pulleys to the main can decorator power supply and the inker drive is divided between both sides of the inker frame, thereby providing temperature control of the pulleys.

Further temperature control is typically provided by at least one of the rollers being mounted on a shaft which includes channels for distributing cooling water. These rollers are ideally intermediate (also known as “transfer”) rollers as these rollers typically comprise a ceramic outer surface and cooling of these rollers helps transfer of ink from an adjacent rubber roller to the ceramic surface.

According to another aspect of the present invention, there is provided a method of applying ink to a printing plate in a can body decorator, the method comprising: transferring ink from a tank over a series of rollers including one or more oscillating rollers; characterised by: providing each oscillator roller with a fixed shaft, clamping the position of the fixed shaft; moving a drive shaft longitudinally relative to the fixed shaft and controlling the drive shaft movement with a cam; connecting an outer shaft to the drive shaft and thereby controlling movement of the outer shaft by the cam controlled movement of the drive shaft; and rotating an oscillator roller body by contacting adjacent rollers in the inking station; and distributing ink uniformly across the adjacent roller by transmitting the cam driven axial movement of the outer shaft to the oscillating roller body.

The method of applying ink to a printing plate may comprise moving the outer shaft axially over the fixed shaft by oscillating longitudinal movement of the drive shaft.

### BRIEF DESCRIPTION OF DRAWINGS

A preferred embodiment of the invention will now be described, by way of example only, with reference to the drawings, in which:

FIG. 1 is a schematic view of a decorator having inker stations according to the invention;

FIG. 2 is a schematic side view of ink flow through an ink station according to the invention;

FIG. 3 is a side section of an oscillator roller;

FIG. 4 is a side view of a cam box drive; and

FIGS. 5a and 5b are opposite side views of the inker drive from the front (FIG. 5a) and from the rear (FIG. 5b).

### DESCRIPTION OF EMBODIMENTS

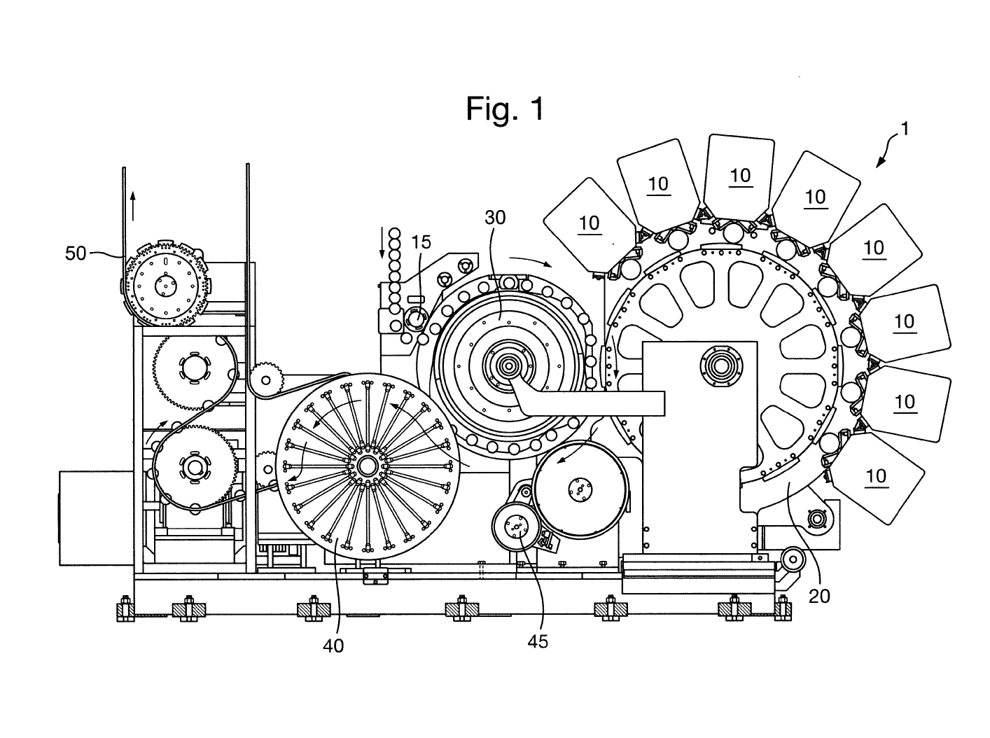

The inking station 10 of the present invention is one of 6 or 8 such stations (eight shown in FIG. 1) provided around a blanket drum 20. The decorator 1 of FIG. 1 is, like the Alcoa Concord prior art decorator, designed around three rotary assemblies. This decorator comprises:
spindle disc 30;
blanket drum 20; and
disc transfer unit 40.

These rotary assemblies are linked via a synchronised drive train and respond to very fine adjustments so as to produce high quality prints with minimum operating pressures. In this description, the terms ‘roll’ and ‘roller’ are used inter-changeably and mean the same thing.

In FIG. 1, a continuous stream of cans is fed from track-work into an in-feed section 15. In the in-feed section 15, individual cans are separated from the stack by rotating an in-feed pocketed turret wheel. The in-feed wheel removes the can from the stack and accelerates the can to the peripheral speed of this turret wheel. As the can is removed from the stack, a vacuum is applied to the can via ports in the pocket surface to ensure transfer stability.

As the in-feed turret rotates, the can is tangentially aligned with a circular spindle that rotates at a matched speed on the spindle drum assembly 30. As the speed and position of the can is matched to the spindle, a simple semi-flexible ‘slapper’ bar contacts the can and slides it laterally towards the speed matched spindle. The can approaches the spindle and a vacuum supply on the end of each spindle continues the can's lateral motion until the can is fully loaded onto its respective mandrel mandrel. A fully loaded can continues into an inking area.

The mandrel and its associated can continue on the circular path but the centre distance from the spindle disc axis to the mandrel axis is adjusted by means of a cam and follower arrangement. As the mandrel approaches the inking area, the mandrel path is modified by the cam action so that its motion is concentric with the axis of the inking blanket drum 20.

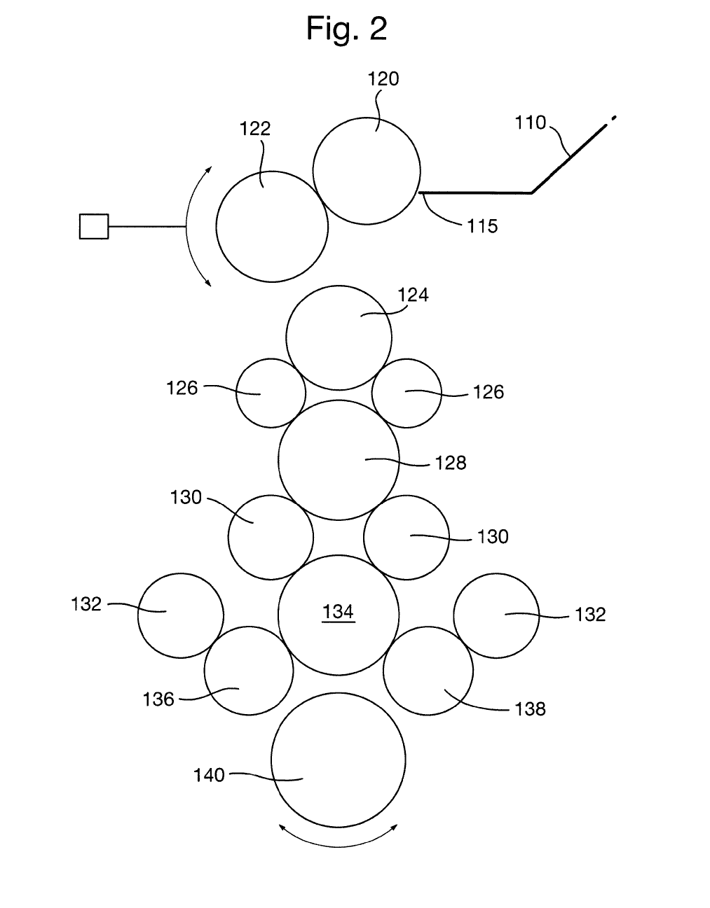

When a can comes into contact with the blanket drum 20 for a pre-set angular displacement, an amount of ink that has been deposited onto the surface of the blanket is transferred to the can's outer surface as described with reference to the inking stations and FIGS. 2 to 5.

The blanket drum 20 rotates in the opposite direction to the spindle disc 30 so as to bring the blanket drum into contact with plate cylinders. Each plate cylinder rotates and picks up a thin film of ink from the inker station.

The inker unit comprises a heavy steel frame into which are mounted several drive rollers and a series of driven or idle-type rolls. The driven rolls are powered via an arrangement of belts and pulleys. The idle rolls are driven by radial contact with the drive rollers.

The path of ink through each ink station 10 is shown schematically in FIG. 2. In FIG. 2, the inker station comprises a fountain well 110 or tank which contains a semi-fluid ink of a first colour. The fountain well 110 has a single open end, which is closed off by a fountain roll 120. The open end may be an extension of the well itself or be in the form of blade 115 which is typically of semi-flexible material. The applied pressure of this blade against the fountain roll 120 is manually adjustable by means of a series of ‘fountain keys’. This allows a pre-set amount of ink to be released from the fountain well 110 onto the surface of the fountain roll 120. The blade adjustment and duration of ductor roll engagement provide control of the amount of ink which is allowed into the system.

Ink on the powered fountain roll 120 is partially transferred by tangential contact to a free running ductor roller 122. The ductor roller is fitted with an electronically controlled/pneumatic engagement mechanism. As the mechanism is operated, this disconnects the ductor roller from the fountain roller and makes contact with an upper driven intermediate roller 124 (also known as a first transfer roll), thereby transferring ink from roller to roller in the ink train. The blank box and arrows on FIG. 2 indicate programmed engagement of the ductor roll with the first transfer roll.

From the upper driven intermediate roller 124, ink passes to a pair of free-running coated distributor rolls 126 by normal tangential contact. The distributor rollers transfer ink to a middle intermediate roller or second transfer roll 128 by normal tangential contact. The second intermediate roller 128 transfers ink by tangential contact to a pair of coated reciprocating oscillating or ‘ghost’ rollers 130, 132. The two oscillating rollers transfer an amount of ink to the third intermediate roller (also referred to as third or lower transfer roll) 134.

The third and final intermediate roll 134 transfers an amount of ink to two different sized form rolls 136, 138 by tangential contact. The form rollers transfer an amount of ink directly to the raised artwork of a plate cylinder 140 for that inker station. The plate cylinder is contacted by a rubber printing blanket on a blanket segment mounted on the circumference of the blanket drum 20. The blanket drum has 12 blanket segments 22 each of which contacts eight different plate cylinders from respective inker stations before finally making contact with the can mounted on a mandrel of the spindle disc.

Any ink remaining on the form rollers is redistributed by means of lower oscillating rollers on the return contact with the lower intermediate roller (i.e. third transfer roller). As ink is only partially deposited from one roll to the next, there is no direct single path of ink flow from the fountain roll to the plate cylinder. Instead, it is possible that any remaining ink is returned to the top of the system. This improves the general consistency of the ink around the inker station and, as a consequence, improves image quality. The recirculating configuration of rolls also assists in the flushing or cleaning of ink when a colour change is required.

The three intermediate or “transfer” rollers are typically made from steel coated by a ceramic material. One feature of the present invention is the provision of channels through the shaft of these rollers, through which coolant such as cooling water, is fed in order to maintain the temperature of the outside of the ceramic rollers at a constant temperature which is essential for optimum ink transfer control.

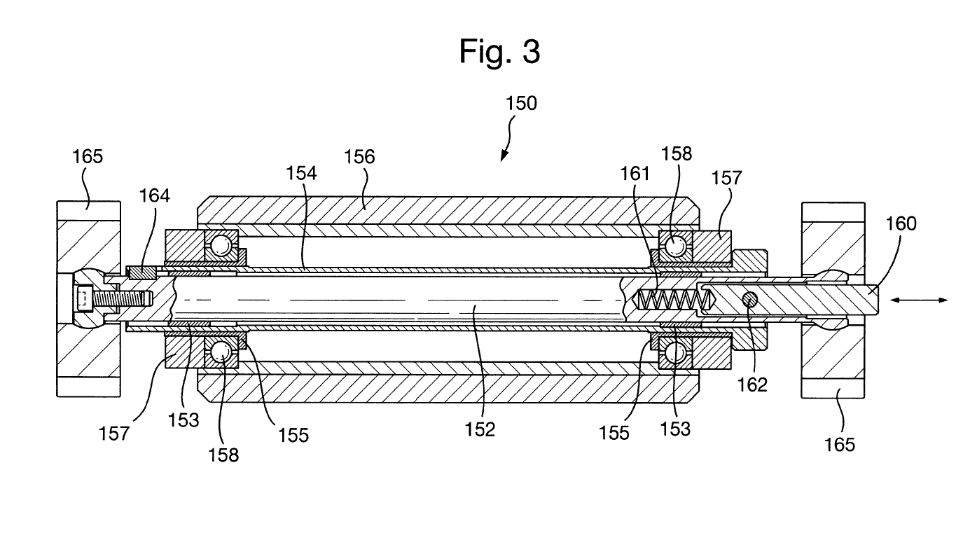

The inker station of the present invention is particularly characterised by the oscillating roller design of FIG. 3. FIG. 3 shows a side section of an oscillating roller 150 having a fixed shaft inner shaft 152, an outer shaft 154 and an outer roller body 156.

Bushes 153 allow longitudinal movement of the outer shaft 154 whilst the collets 155 and clamp rings 157 clamp collet 155 to outer shaft 154 to prevent rotation of the outer shaft. In addition, an anti-rotation key 164 at the left hand side of FIG. 3 prevents any rotation of the outer shaft. The clamp block 165 fixes the position of fixed inner shaft 152. The oscillating roller body 156 of FIG. 3 comprises an aluminium core 156′ and an outer part of bonded rubber. The bearings 158 support and hold the roller body 156.

Longitudinal movement of the outer shaft 154 is controlled by a flat faced cam which is applied to the outer end of drive shaft 160 within the core of fixed inner shaft 152. Compression of spring 161 assists in returning movement of the outer shaft 154 and in maintaining the drive shaft in contact with the cam.

As noted above, the principal reason for oscillating the rollers in the inker station is to distribute the transferred ink uniformly across the roller and to “smooth out” any excess ink that may have transferred during the inking process. In the inker stations of the present invention, the image is ultimately to be transferred to a metal can body, typically of steel or aluminium. This necessitates use of rubber coated outer roller 156 which is driven to move axially while the central shaft 154 remains fixed between two holding clamps within the frame side of the inker. Rotation of the outer diameter of the roller 156 is by contact with adjacent rollers.

The printed cans are passed to an over-varnish unit 45 where the cans receive a varnish layer to protect the finished design, and, finally, transferred to the disc transfer wheel 40 and deco chain 50 from which each can is released and subsequently dried in an oven.

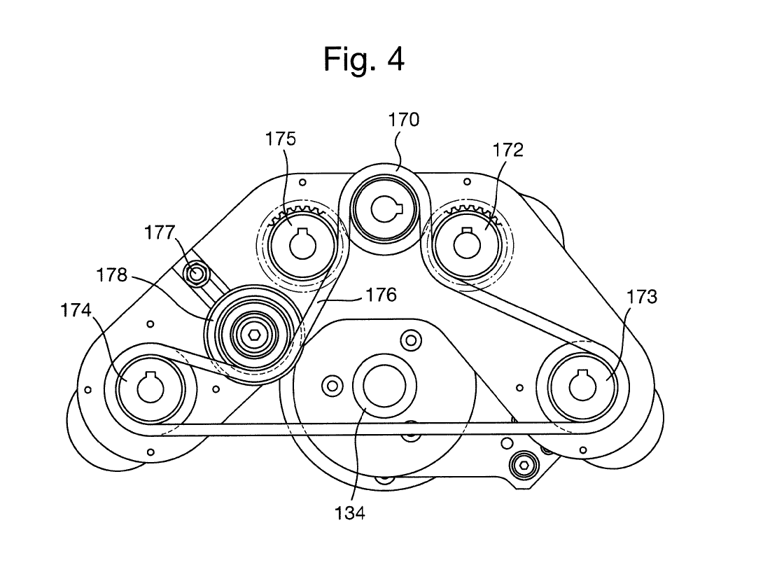

FIG. 4 is as side section of a cam box drive which is adapted to move the oscillating rollers laterally, using the flat face cam arrangement for each oscillating roller. There is an individual cam box drive for each inking station.

Each cam box drive of the present invention comprises a central drive pulley 170 and four subsidiary pulleys 172, 173, 174, 175. The drive belt 176 can be tensioned by adjustment of tensioner 178 using adjuster nut 177. The subsidiary pulleys rotate the flat faced cam which controls longitudinal movement of the outer shaft 154 of FIG. 3.

The central roller shown in FIG. 4 is an intermediate roller and the design of FIG. 4 is particularly advantageous in providing access for a cooler unit and cooling water pipes for the intermediate rollers.

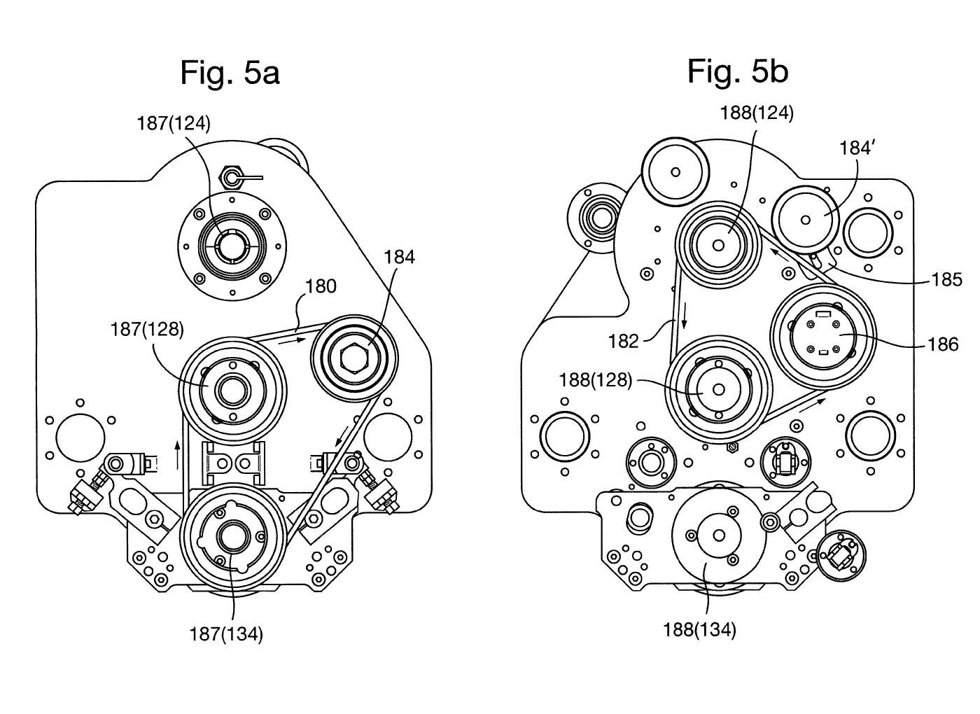

Drive for each of the inker stations is provided by the novel drive layout of FIG. 5, in which the drive from the inker clutch operates the main drive pulley and is divided to both sides of the inker. The inker rollers are driven via a coupling to the inker clutch which can be engaged pneumatically. In FIG. 5, the three intermediate (also known as transfer) rollers are shown centrally 124, 128 and 134 and are connected to separate pulleys 187, 188 on each side of the inker. Each drive belt 180, 182 operates two of the transfer rollers via tensioner pulleys 184 or 184′. The tensioner 185 is moved to tighten the pulleys 184 and 184′.

The power from the main machine drive system is thus distributed evenly to both sides of the inker frame which enables increased tensioner pulley size to be used in comparison with known drive pulleys. This splitting of the drive system has been found to provide improved temperature control in contrast with known single drive systems and in particular the tensioner temperature is controlled to a lower level than in known single drive inker systems.

The invention has been described above by way of example only and changes may be made to the inking station without departing from the scope of the invention as defined by the claims.

1. An inking station for a can body decorator, the inking station comprising:
a fountain tank for holding and/or releasing ink;
a blade for metering ink from the tank to a fountain roll;
a series of rollers for transferring ink from the fountain roll to a plate cylinder;
the series of rollers includes at least one oscillating roller;
each oscillating roller comprising:
a fixed shaft,
a clamp for fixing the position of the fixed shaft,
a drive shaft movable relative to the fixed shaft,
a cam for controlling movement of the drive shaft,
an outer shaft connected to the drive shaft and moveable in response to the cam controlled movement of the drive shaft, and
an oscillating roller body that is configured to be rotatable when, in use, it contacts adjacent rollers in the inking station;
whereby the inking station is configured such that, in use, the cam driven axial movement of the outer shaft is transmitted to the outer face of the oscillating roller body and distributes ink uniformly across the adjacent roller, and contact of the outer oscillator roller body with adjacent rollers rotates the outer face of the roller.

2. An inking station according to claim 1, in which the drive shaft and outer shaft include complementary biasing means such that oscillating movement of the drive shaft causes the outer shaft to move axially over the fixed shaft.

3. An inking station according to claim 1, further comprising a slot in the shaft of each oscillating roller through which a pin, in use, moves the outer shaft of the oscillating roller.

4. An inking station according to claim 1, in which the oscillator roller body is mounted on roller bearings.

5. An inking station according to claim 1, further comprising a housing for the oscillating roller or rollers.

6. An inking station according to claim 5, in which the housing is a cam box and the cam is a flat faced cam arrangement for each oscillating roller.

7. An inking station according to claim 1, further comprising a drive for the inker rollers, which is connected via one or more pulleys to the main can decorator power supply and the inker drive being divided between both sides of the inker frame, thereby providing temperature control of the pulleys.

8. An inking station according to claim 1, in which at least one of the rollers is mounted on a shaft which includes channels for distributing cooling water.

9. A method of applying ink to a printing plate in a can body decorator, the method comprising:
transferring ink from a tank over a series of rollers including one or more oscillating rollers; each oscillator roller having a fixed shaft,
clamping the position of the fixed shaft;
moving a drive shaft longitudinally relative to the fixed shaft and controlling the drive shaft movement with a cam;
connecting an outer shaft to the drive shaft and thereby controlling movement of the outer shaft by the cam controlled movement of the drive shaft; and
rotating an oscillator roller body by contacting adjacent rollers in the inking station; and
distributing ink across the adjacent roller by transmitting the cam driven axial movement of the outer shaft to the oscillating roller body.

10. A method of applying ink to a printing plate according to claim 9, comprising moving the outer roller axially over the fixed shaft by oscillating longitudinal movement of the inner roller.

11. The method of claim 9 in which the step of distributing the ink is distributing the ink uniformly.

12. The inking station according to claim 2, in which the biasing means is a spring.
